(19) United States
(12) Patent Application Publication
(10) Pub. No.: US 2012/0268014 A1
(43) Pub. Date: Oct. 25, 2012

(54) Comparative Lighting Network

(75) Inventors: Brock Johnston, Victoria (CA); Bruce Bernard, Victoria (CA); Don Hargreaves, Victoria (CA)

(73) Assignee: Carmanah Technologies Corp., Victoria, BC (CA)

(21) Appl. No.: 13/515,484

(22) PCT Filed: Dec. 16, 2009
(86) PCT No.: PCT/CA2009/001884

§ 371 Date: Jun. 12, 2012

(51) Int. Cl. H05B 37/02

(52) U.S. Cl. 315/132

(57) ABSTRACT

A network of lighting elements controlled by a control system, in which the control system receives and analyzes operating conditions from the lighting elements in the network, from which it can determine whether any lighting elements are operating at unacceptable levels. The analysis is carried out by averaging the values received from the lighting elements to determine a baseline value and determining whether any deviate from the baseline value by more than a pre-determined amount. Alternatively, the analysis may be done by finding the distribution of the values and mode value, and determining whether any individual values are outside an acceptable distribution.

### FIELD OF THE INVENTION

This invention relates to a lighting network which analyzes information from various lighting elements in the network to determine whether any are operating at parameters significantly different than those of the other lighting elements, and then takes appropriate action.

### BACKGROUND OF THE INVENTION

In a network consisting of several lighting elements, it is beneficial to be able to monitor the condition of each light, in order to ensure that it is working properly. The simplest way to do this is manually, by having an operator visually inspect each light to verify that it is active at a given time, and that it appears to be synchronized with its neighbouring lights. However this is a very time consuming process, particularly with lighting networks spread out over a large area, and may not have a high degree of reliability. For example, if the network is programmed to operate according to different sets of parameters at different times of the day, the operator will not be able to verify that each light is operational at each set of parameters without making multiple inspections.

It is therefore preferable to automate the monitoring of the lighting elements in the network. U.S. Pat. No. 5,479,159 discloses an apparatus and system for monitoring street lights wherein a basic signalling module associated with each lamp monitors the current taken by the lamp, and stores it until interrogated by a logger. The data is then sent to the logger, which stores the data until it is interrogated by a data collection unit. The data is sent to the data collection unit, where it is stored until being loaded onto a computer for analysis. The computer uses the information to produce a list of faulty lamps, as well as a list of possible faults for each lamp. Clearly, there can be some delay in this system between the time a fault arises in a lamp and the time that an operator is notified of the fault and is able to address it.

It is therefore also preferable to have a system which is capable of immediate data analysis, in order to create an immediate reaction if a problem arises with one or more lights. U.S. Pat. No. 7,539,882 discloses a central controller that obtains status updates from self-powered devices in the network, compares them to reference values that have been pre-determined and programmed into the central controller, and reacts if the communicated status is unsatisfactory, or if no update is received at all. U.S. Pat. No. 4,451,822 also discloses a system that measures intensity of electric current and voltage passing through each light in the system and compares it to a pre-stored nominal value. European Patent No. 0880308 discloses a lighting monitoring system that initially measures a parameter, namely voltage, and compares the measured voltage to a theoretical or design voltage, less any load losses, in order to detect operating abnormalities in the system. If no abnormalities are detected, the monitoring system allows the lamps to activate. Once the lighting system is activated, the monitoring system gathers further information, such as current absorbed by each lamp and the power factor for the system, and again compares the readings to stored normal data to provide information as to the operational status of the lighting system.

In these systems, difficulty will arise if all or part of the network is subject to a condition that skews the information sent to the central controller. As an example, the information communicated to the central controller may be related to the actual amount of sunlight being received by a solar panel associated with each lighting element. If the sun is temporarily obscured for any reason, such as dense clouds, smoke or a solar eclipse, the values received by the central controller from lighting elements in the dark area will be outside the pre-determined reference value. The central controller will therefore indicate that several lights are malfunctioning, which is inaccurate and unnecessary due to the relatively temporary nature of the condition.

U.S. Pub. No. 20090039797 is an energy conservation system that senses environmental conditions to generate reference information. Specifically, the controller receives a series of signals from a light which it averages to form sample windows. The trend formed by the various sample windows tell the controller whether conditions exist that require action (e.g. decreasing environment light levels will indicate that the light should be activated). Use of this method may assist in avoiding unnecessary alerts due to temporary conditions, although it may also decrease the responsiveness of the system to changing environmental conditions. The system does not address individual readings that differ substantially from other readings, but tends to simply ignore a certain percentage of readings obtained, as those readings are more than 3 standard deviations from the median. In some cases, the system assumes that a data point is caused by a system problem, so resets the system, rather than identifying the specific light that sent the erroneous signal. Further, as the system does not appear to be adapted to analyze data from multiple sources, each light requires its own controller, making it equipment- and labour-intensive, and increasing the associated costs of installing and maintaining the network.

U.S. Pat. No. 3,715,741 consists of a network of airport runway lights, monitored by a master controller, but has a large number of intervening components, including two fault detectors associated with each light and a field data acquisition unit associated with each group of 16 lights; the field data acquisition units then communicate with the master controller. Again this system is rather equipment heavy, labour-intensive and expensive to install and maintain.

A series of U.S. patents and applications to Walters et al. (U.S. Pat. Nos. 7,603,184, 7,546,128, 7,546,167, 7,529,594, 7,333,903, and U.S. Pub. No. 2007/0085701) disclose a luminaire network in which luminaries are monitored by networked luminaire managers, which gather status information about the luminaires and send the information to a master control, which forwards it to a network operations center. The information is then forwarded to the operator of the network. The managers comprise synchronized internal clocks, from which date and time stamps can be added to various data transmissions between various components of the system. Faulty luminaires are detected by periodic measurement of the power or voltage in the luminaire. The system uses a relatively complicated analysis to determine real and apparent power ratios and current readings and to compare them to different pre-stored threshold values. In addition to being rather equipment heavy, labour-intensive and expensive to install and maintain, the system appears to closely monitor individual light health, but does very little to indicate the health of the system as a whole.

U.S. Pat. No. 7,417,397 discloses a system that receives readings from several radiometers or other environmental sensors, and determines whether any are outside of a pre-determined range. If so, an error message is produced. Readings from those radiometers that are not out of range are averaged, thereby obtaining a compare value which is used to determine the environmental conditions. The system then takes the appropriate action, based on the compare value. Again, this system does not appear to address the issue of a widespread, but temporary, condition that affects the information received from several lighting elements. In another embodiment, the system may receive readings from various sensors and average them in order to determine and respond to localized conditions. In this case, a reading that deviates substantially from those provided by other sensors will badly skew the averaged results, perhaps leading the system to respond inappropriately to the actual environmental conditions.

It is therefore an object of this invention to provide a lighting network that overcomes the foregoing difficulties.

These and other objects of the invention will be better understood by reference to the detailed description of the preferred embodiment which follows.

### SUMMARY OF THE INVENTION

This invention relates to a network of lighting elements, each having means to communicate information about its status and operating parameters to a control system. The control system analyzes the information to ensure that each lighting element is operating within an acceptable range. The analysis consists of calculating a new baseline value based on the received information each time new parameter values are received, and then determining whether any of the received parameter values exceeds the baseline value by a significant amount.

The baseline value may be calculated as the average of the parameter values received for any particular parameter. If the value received from any individual lighting element deviates significantly from the baseline value, appropriate action may be taken. The acceptability of the deviation may be determined and pre-programmed, for example to flag any parameter values that differ from the baseline value by a certain percentage or a minimum amount.

In an alternate embodiment, the baseline value may be calculated by determining the distribution of the values received from individual lighting elements, and assigning the mode value as the baseline value. If the distribution is normal, each parameter value may be compared to the mode value, to ensure that it is within an appropriate number of standard deviations from the mode value.

If no light provides a parameter value that differs significantly from the baseline value, the control system may take no action, or may send a “clear” or other confirmation signal to a remote monitor. The control system may then wait for the next set of parameter values to be transmitted from the individual lights.

However, if one or more lights provide a parameter value that deviates significantly from the established baseline value, the control system can transmit an alert to a remote monitor, identifying each individual lighting element with a deviating parameter value, which should then be checked.

In one aspect, the invention comprises a lighting network comprising a plurality of lights, each of the lights having means to communicate status information relating to the light to a control system, the status information comprising at least one value for an operational parameter of the light; the control system comprising processing means for: receiving the status information; performing a statistical analysis on the values to determine a baseline value; and comparing each of the values to the baseline value and determining whether the value corresponding to each of the lights deviates from the baseline value by a predetermined amount.

In a further aspect, the baseline value may be an average of the transmitted values, or may be a mode of the values. The predetermined amount may be a predetermined number of standard deviations from said baseline value.

In a further aspect, the network may further comprise means for communicating to an operator a deviation of a value from the baseline value, which means may be making a recorded log of a deviation from the baseline value. The network may also comprise means to signal to an operator when the values received from the lights do not deviate from the baseline value by a predetermined amount, i.e. to transmit a “clear” signal. The network may further comprise means for communicating to an operator a failure of at least one lighting element to provide any status information. In a further aspect, the operational parameters may be selected from the group of operational parameters comprising: stored power levels, active flash patterns, received sunlight levels, light activation time, light deactivation time, solar panel voltage, solar panel current, battery voltage, battery current, and light source voltage and light source power. The operational parameters may also be selected from the group of operational parameters comprising temperature, humidity, pressure, motion and sound levels.

In another aspect of the invention, the status information may further comprise location information to locate a specific light communicating said information, and/or an emergency signal.

In another aspect, one or more or each of the plurality of lights may comprise the control system.

In yet another aspect, one or more of the lights may act as a gateway between the control system and a subgroup of lights.

In a further aspect, the invention comprises a method of monitoring a lighting network comprising the steps of receiving status information from each of a plurality of lights, the status information comprising at least one value for an operational parameter of the light; performing a statistical analysis on the values to determine a baseline value; comparing the status information to the baseline value; and determining whether the value corresponding to each of the lights deviates from the baseline value by a predetermined amount, such as a predetermined number of standard deviations from the baseline value. The baseline value may be calculated as an average or a mode of the transmitted status information.

The method may further comprise the step of communicating to an operator a deviation of a value from the baseline value, and/or providing a clear signal to an operator when no light has provided status information that deviates from the baseline value by the predetermined amount. The communication to an operator may comprise a recorded log of a deviation from the baseline value, and may further comprise communication to an operator of a failure of at least one lighting element to provide any status information.

The transmitted status information may comprise location information to locate a specific light communicating the information, and/or may comprise an emergency signal.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

The invention will be described by reference to the detailed description of the preferred embodiment and to the drawings thereof in which:

FIG. 1 is a schematic of the components of the lighting network;

FIG. 2A is a flowchart of the operation of the lighting network;

FIG. 2B is a flowchart of an alternative operation of the lighting network; and

FIG. 3 is a sample distribution of individual values created during operation of the lighting network.

### DETAILED DESCRIPTION OF THE PREFERRED EMBODIMENT

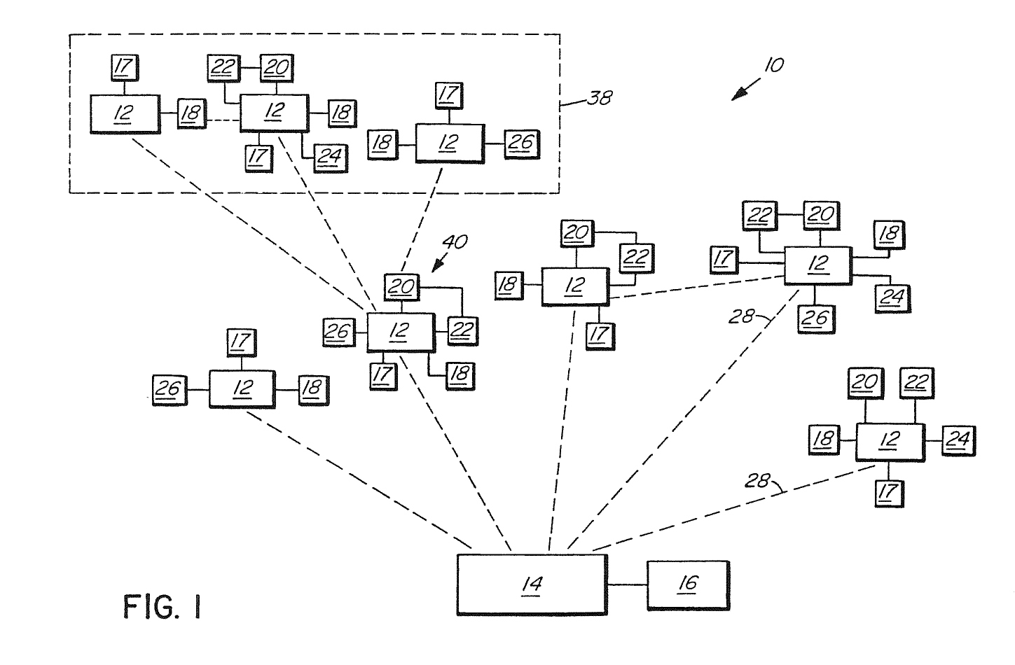

Referring to FIG. 1, the lighting network 10 comprises a plurality of separate installed lighting elements 12. The lighting network 10 may be placed in any location in which coordinated lighting is desired, including, but not limited to, parking lots, walkways, airport runways and park areas. The lighting network 10 is in wired or wireless communication with a control system 14. The lighting network may comprise one or more subgroups 38 of lighting elements 12, of which one lighting element 12 acts as a gateway 40, which communicates with control system 14 using an appropriate wired or wireless method.

Control system 14 is in turn in communication with a monitor 16, which may be local, or which may be a remote system. Control system 14 may be a dedicated control system or may be part of any one of the lighting elements 12 in network 10. Alternatively, lighting network 10 may be programmed to rotate or otherwise move control of the system among any or all of the lighting elements 12 in the network 10. Each of lighting elements 10 may comprise components such as light source 17, communications module 18, solar panel 20, rechargeable battery 22, GPS module 24, and/or a sensor bank 26, to allow the lighting element 12 to monitor its own immediate surroundings.

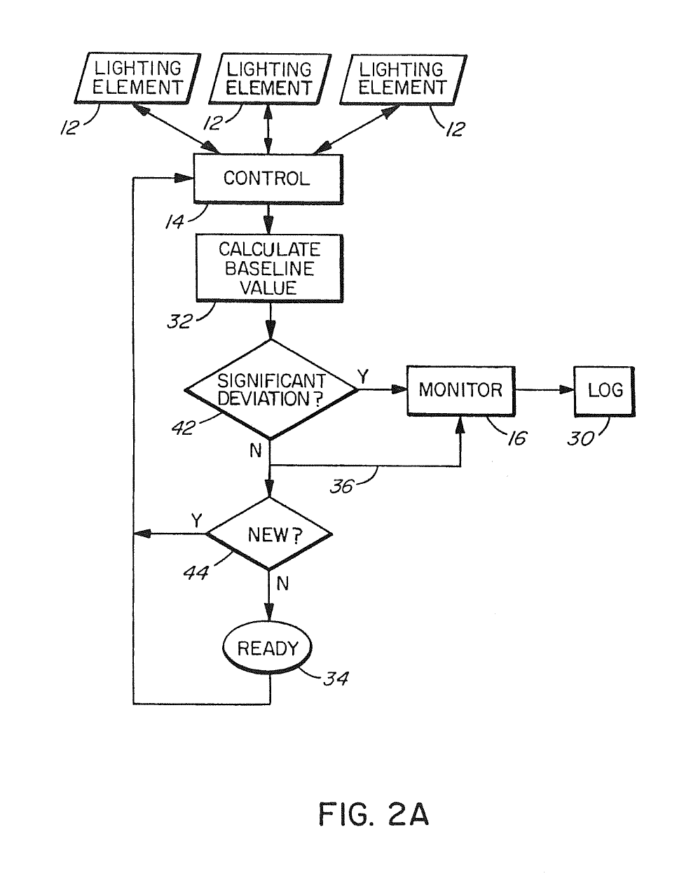

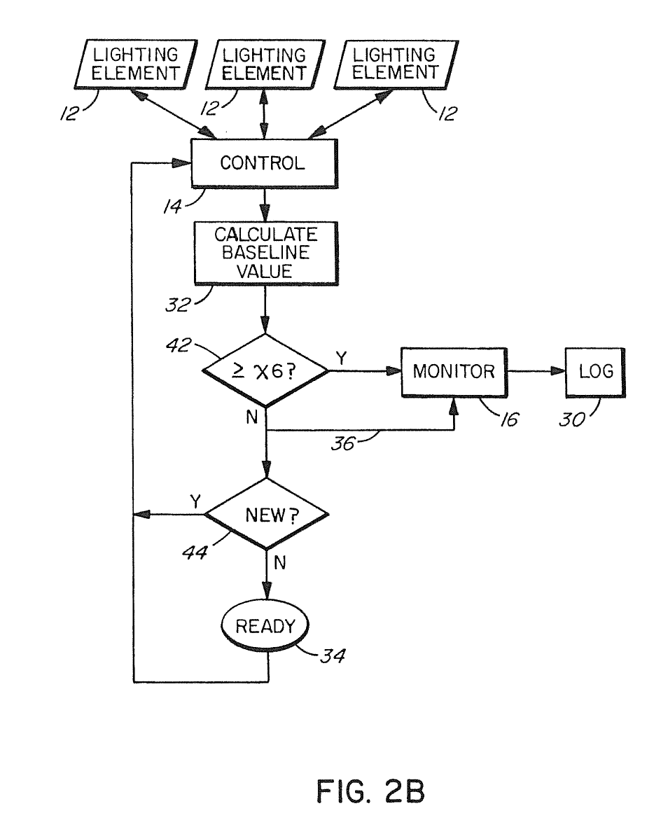

In operation, as best shown in FIGS. 2A and 2B, each of the lighting elements 12 communicates status information about its own operating parameters to the control system 14. The status information preferably includes or comprises at least one numerical value, or can be equated to a numerical value, and can be related to parameters such as stored power levels, active flash patterns, received sunlight levels at varying times of the day, light activation and deactivation times, solar panel 20 voltage and current readings, battery 22 voltage and current readings, and light source 17 voltage and power. The status information can further include information obtained from sensor bank 26, such as local temperature, humidity, pressure, motion, sound, or any other relevant conditions. The status information may also be a direct emergency signal, for example if the lighting element 12 has been tampered with, if its local components are malfunctioning, or if it is otherwise in need of attention.

On receipt of the status information, the control system 14 analyzes the value for a given parameter from each individual lighting element 12 to produce a baseline value 32 for that parameter. In one embodiment, best shown in FIG. 2A, the control system 14 may determine the baseline value 32 for a parameter by simply calculating the average or arithmetic mean of the individual values received from the lighting elements 12. Each value received from an individual lighting element 12 is then compared 42 to the calculated baseline value 32, in order to ensure that the two values are acceptably close. The control system 14 can be programmed to take appropriate action if the value received from one or more lighting elements 12 differs from the baseline value by a pre-determined percentage, or by a pre-determined amount, depending on the parameter and the sensitivity desired from the system.

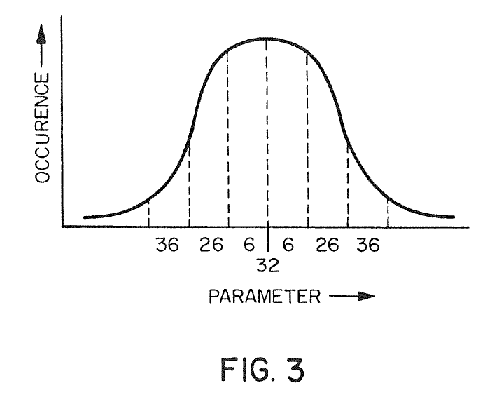

In another embodiment, best shown in FIG. 2B, the control system 14 may analyze the individual values by determining the frequency of each value. Statistically, the distribution of the frequency of each value will tend to be a normal, or Gaussian, distribution, as shown in FIG. 3. From the data, the control system 14 can then determine a baseline value 32 of the parameter, which would be the mode, or most frequently occurring, value, as well as the number of standard deviations (σ) of each individual value from the baseline value. If the control system 14 determines 42 that any individual value is more than an acceptable number of standard deviations away from the baseline value 32, the individual lighting element 12 is identified and a notice is sent to monitor 16. In a typical case, Gaussian distribution means that 99.7% of the readings are within 3σ of the baseline value and 95% of the readings will fall within 2σ of the baseline value. The amount by which a given lighting element's operating parameter can deviate from the baseline value 32 can be selected based on how sensitive the operator requires the system to be.

If no individual lighting element 12 has transmitted a parameter value that differs significantly from the baseline value 32, the control system 14 can simply settle into a “ready” mode 34, waiting for the next set of parameters to be transmitted. Alternatively, the control system 14 can provide a “clear” signal or other indication 36 to monitor 16, by any suitable wired or wireless communication means, that the lighting elements 12 are functioning normally. In a further alternative, control system 14 can immediately begin receiving status information from another set of lighting elements 12, or begin receiving a new set of status information from the same lighting elements 12. In any case, the control system 14 may create or add to a record or log 30 listing or summarizing the information received and the calculations performed in assessing the parameters received.

However, if control system 14 determines 42 that any individual value differs from the baseline value 32 by more than the pre-determined acceptable amount, control system 14 may identify the individual deviating lighting element 12, and may send a notice to monitor 16, again by any suitable wired or wireless communication means. An operator can then be dispatched to assess and respond to the problem. Control system 14 may create or add to a record or log 30 of the information received and the calculations performed in assessing the parameters received, as well as the action taken. Alternatively, the record or log 30 can simply be stored until an operator checks it to determine which lighting elements 12 should be checked. This feature might be useful, for example, in a more remote location where immediate action is not strictly necessary, but where an operator needs to have an updated list of issues that have arisen with the lighting network 10 so those issues can all be dealt with at once, and so that the operator can ensure he has sufficient instruments, components, etc. to deal with all of the issues.

Control system 14 can also be programmed to notify monitor 16 if it does not receive any status information from one or more of the lighting elements 12. Control system 14 preferably knows how many individual lighting elements 12 are to provide status information at a given time, and the location of each. If any one or more lighting elements 12 fails to send status information to control system 14, an immediate alert can be sent to monitor 16, so that an operator can be dispatched to tend to the problem. Alternatively or in addition, the information can be added to record or log 30, as described above.

In a more extreme situation, such as an unacceptably high number of lights failing to send status information, the control system may provide an emergency signal to monitor 16, or directly to an operator, who may wish to respond immediately. In the situation where one or more lighting elements 12 do not provide a signal, the control system 14 would preferably carry out the statistical analysis using only the status information values actually received, and would not include the missing lighting element or elements 12 in the computation. This type of intelligent monitoring prevents unreceived or nil values from skewing the overall average or mode baseline values for the network 10.

The status information is preferably accompanied by location information 28 (shown in FIG. 1) to identify the lighting element 12, such as GPS 24 coordinates, to allow control system 14 to match the information received with a specific lighting element 12. A map of the location of lighting elements 12 may then be produced and provided to monitor 16, or monitor 16 may use the GPS coordinates to produce a map or directions to help the operator to locate the problematic lighting elements 12. Location information 28 may also comprise an identification code or some other information that can be correlated, such as by an internal database or lookup table, to an individual lighting element 12. The database or lookup table can be programmed into control system 14, which can then provide the information to a monitor 16, as described. Alternatively, the location information can simply be provided via the monitor 16 to an operator who would use suitable means, such as a GPS positioning device or a paper or digital database or lookup table, to correlate the location information 28 to a specific lighting element 12.

All communications among lighting elements 12, between the lighting elements 12 and control system 14, and between control system 14 and monitor 16, may be by any appropriate means, wired or wireless, depending on the nature and size of the lighting network. Information may be communicated by a cellular signal, Bluetooth, WiFi, Zigbee, GSM, etc., as well as by a direct download of any stored information, as appropriate.

Localized environmental changes affecting an individual lighting element 12, such as an overgrown plant or weed, or a newly-erected structure, are therefore immediately caught and flagged. An operator can immediately identify which light is not operating properly, and visit the light to address the problem, for example by removing the offending plant or structure, or moving the lighting element 12, if necessary.

In the case of a more widespread environmental condition, such as particularly dense clouds, smoke, or a solar eclipse, the individual value for each of the lights 12 will be lower, thereby lowering the mean value. If each lighting element 12 is working correctly, few, if any, individual values will deviate substantially from the calculated baseline value. Comparing the individual values with a baseline value that is directly determined from those individual values offers flexibility in adapting to changing environmental conditions, and helps to avoid false readings in cases where many lights are adversely affected by an environmental condition, but are otherwise operating correctly. This saves the time and expense involved in sending out an operator to check on one or more lights that are actually functioning well.

It will be appreciated by those skilled in the art that the preferred and alternative embodiments have been described in some detail but that other modifications may be practiced without departing from the principles of the invention.

1. A lighting network comprising:
a plurality of lights, each of said lights having means to communicate status information relating to said light to a control system, said status information comprising at least one value for an operational parameter of said light;
said control system comprising processing means for:
receiving said status information;
performing a statistical analysis on said values to determine a baseline value; and
comparing each of said values to said baseline value and determining whether the value corresponding to each of said lights deviates from said baseline value by a predetermined amount.

2. The network of claim 1 wherein said baseline value is an average of said values.

3. The network of claim 1 wherein said baseline value is a mode of said values.

4. The network of claim 3 wherein said predetermined amount is a predetermined number of standard deviations from said baseline value.

5. The network of claim 1 wherein said operational parameters are selected from the group of operational parameters comprising: stored power levels, active flash patterns, received sunlight levels, light activation time, light deactivation time, solar panel voltage, solar panel current, battery voltage, battery current, and light source voltage and light source power.

6. The network of claim 1 wherein said operational parameters are selected from the group of operational parameters comprising temperature, humidity, pressure, motion and sound levels.

7. The network of claim 1 wherein said status information further comprises location information to locate a specific light communicating said information.

8. The network of claim 1 wherein said status information comprises an emergency signal.

9. The network of claim 1 further comprising means for communicating to an operator a deviation of a value from said baseline value.

10. The network of claim 9 wherein said means for communicating to an operator comprises a recorded log of a deviation from said baseline value.

11. The network of claim 1 wherein said control system further comprises means to signal to an operator when the values received from said lights do not deviate from said baseline value by said predetermined amount.

12. The network of claim 1 wherein said control system further comprises means for communicating to an operator a failure of at least one lighting element to provide said status information.

13. The network of claim 1 wherein one of said plurality of lights comprises said control system.

14. The network of claim 1 wherein each of said lights further comprises said processing means.

15. The network of claim 1 wherein at least one of said lights acts as a gateway between said control system and a subgroup of said lights.

16. A method of monitoring a lighting network comprising the steps of.
receiving status information from each of a plurality of lights, said status information comprising at least one value for an operational parameter of said light;
performing a statistical analysis on said values to determine a baseline value;
comparing said status information to said baseline value; and
determining whether the value corresponding to each of said lights deviates from said baseline value by a predetermined amount.

17. The method of claim 16 further comprising the step of communicating to an operator a deviation of a value from said baseline value.

18. The method of claim 16 wherein said baseline value is an average of said status information.

19. The method of claim 16 wherein said baseline value is a mode of said status information.

20. The method of claim 16 wherein said predetermined amount is a predetermined number of standard deviations from said baseline value.

21. The method of claim 16 further comprising the step of providing a clear signal to an operator when no light has provided status information that deviates from said baseline value by said predetermined amount.

22. The method of claim 16 wherein said status information further comprises location information to locate a specific light communicating said information.

23. The method of claim 17 wherein said means for communicating to an operator comprises a recorded log of a deviation from said baseline value.

24. The method of claim 16 wherein said status information comprises an emergency signal.

25. The method of claim 16 wherein said control system further comprises means for communicating to an operator a failure of at least one lighting element to provide said status information.
